(19) United States
(12) Patent Application Publication
(10) Pub. No.: US 2025/0361122 A1
(43) Pub. Date: Nov. 27, 2025

(54) CRANE

(71) Applicant: Boat Lift S.r.l., Diano d'Alba Cuneo (IT)

(72) Inventors: Ezio PIRA, Diano d'Alba Cuneo (IT); Alex CARDONE, Diano d'Alba Cuneo (IT)

(21) Appl. No.: 18/873,919

(22) PCT Filed: May 22, 2023
(86) PCT No.: PCT/IB2023/055237

§ 371 Date: Dec. 11, 2024

(30) Foreign Application Priority Data
Jun. 15, 2022 (IT) 102022000012692

(51) Int. Cl. B66C 19/00; B63C 3/06; B66C 1/18; B66C 13/02; B66C 23/74

(52) U.S. Cl. CPC B66C 19/00; B66C 1/18; B66C 23/74; B63C 3/06; B66C 13/02

(57) ABSTRACT

A crane includes: a first frame to which one or more motion units are coupled, each motion unit being configured for the support and motion of the crane on the ground and a second frame installed on said first frame, where the second frame includes a lifting portion including one or more lifting supports. The lifting portion is arranged projecting with respect to the first frame in such a manner that a projection on the ground of the lifting portion is arranged alongside a projection on the ground of the first frame.

### FIELD OF THE INVENTION

The present invention refers to handling cranes. Specifically, the invention has been developed with reference to cranes for handling boats in harbours or shipyards, and to handling cranes for industrial uses or for construction.

### KNOWN ART

The handling of boats in harbours or in shipyards is generally performed by double-track movable lifting cranes (i.e., cranes having a double row of motion members, e.g. tyred wheels), wherein the crane comprises a frame having a double-gantry structure, wherefrom a plurality of lifting bands are suspended (a so-called “straddle crane”). Specifically, the lifting bands are suspended between both gantry structures, so that the projection thereof on the ground is substantially contained within the crane frame, and specifically within a perimeter which unites the positions where the motion members are located. In other words, the boat is lifted and carried in a position comprised between both gantry-shaped frames.

This structure is not devoid of drawbacks. The main disadvantage concerns the features of the area where the transported boat is released: due to the crane structure, the crane must be positioned astride the release area. This practically limits the possible release areas to basins or docks having two banks (one for each crane track), or to canals. In the case of docks or quays directly facing the water, it is impossible to position the crane in such a way as to release the boat directly into the water, which requires additional operations and/or equipment.

Moreover, it shall be borne in mind that the morphology of the area where the release of a load takes place may also affect applications other than boat handling. One example is the use of cranes in the industrial or construction sector: when handling bulky objects, it is not always possible to expect the presence of release areas shaped in such a way as to enable the use of double gantry cranes (straddle cranes), or generally of cranes which are adapted to operate rapidly about different locations. Typically the use is envisaged of fixed handling systems, such as overhead-travelling cranes, with all the related limitations, or else of cranes installed on a vehicle (e.g., mobile cranes), which however are not sufficiently efficient, because they need to be stabilized on the ground (and therefore they require a preparation of the lifting/release site) and cannot be moved easily.

### OBJECT OF THE INVENTION

The invention aims at solving the problems described in the foregoing. Specifically, the invention aims at providing a crane for boat handling which enables releasing and picking up a load (e.g., releasing a boat in the water and picking up a boat from the water) irrespective of the morphology and the features of the release or pickup site. In the case of boat handling, this includes releasing or picking up from any dock, basin or quay, even though they directly face the water.

### SUMMARY OF THE INVENTION

The object of the invention is achieved by means of a crane having the features set forth in the claims that follow, which form an integral part of the technical disclosure provided herein in relation to the invention.

### BRIEF DESCRIPTION OF THE DRAWINGS

The invention will now be described with reference to the annexed Figures, which are provided by way of non-limiting example only, and wherein:

FIG. 1 is a perspective view of a crane according to the invention,

FIG. 2 is a view according to arrow II of FIG. 1,

FIG. 3 is a view according to arrow III of FIG. 1,

FIG. 4 is a view according to arrow IV of FIG. 1,

FIG. 5 is a view similar to FIG. 1, but showing the crane in operating conditions,

FIG. 6 is a view according to arrow VI of FIG. 5, and

FIGS. 7 and 8 are views equivalent to FIGS. 6 and 5, but showing another application of the crane according to the invention.

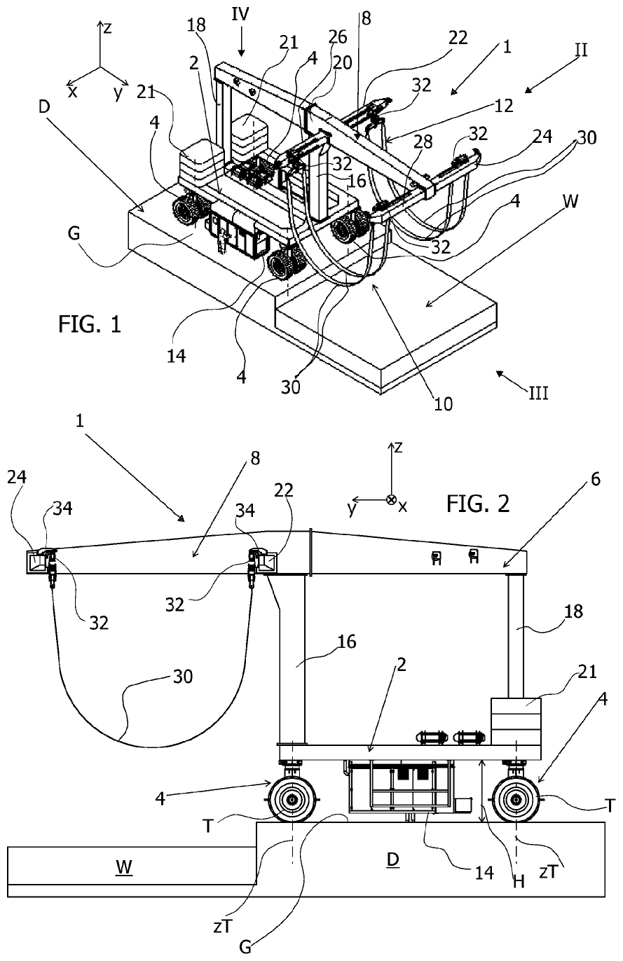

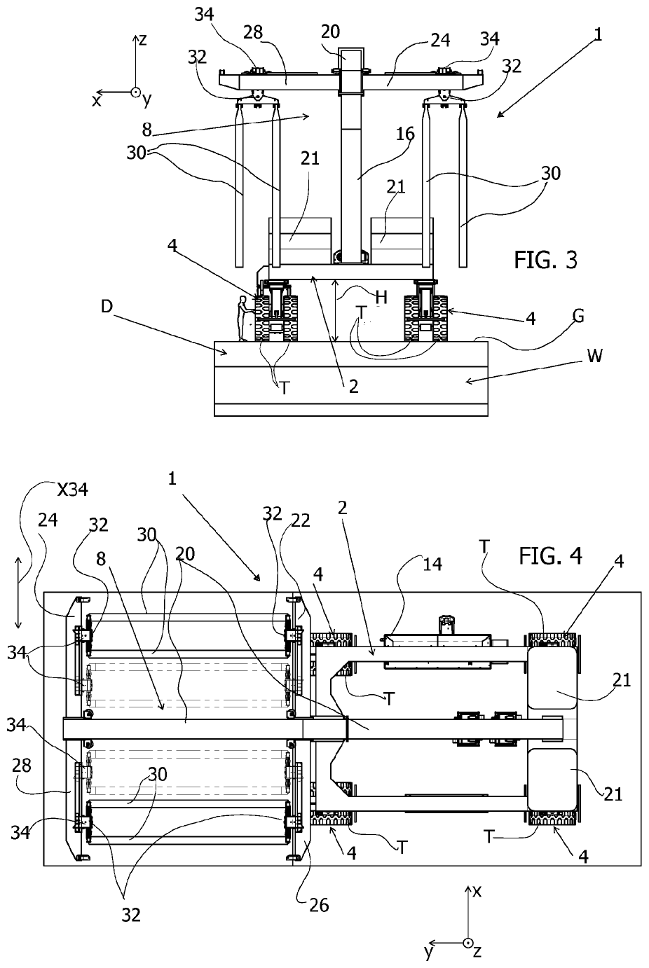

The Cartesian reference system x-y-z shown in FIGS. 1 to 8 defines two horizontal directions x, y and a vertical direction z.

### DETAILED DESCRIPTION

Reference number 1 in the FIGS. 1 to 6 generally denotes a handling crane according to the invention.

In various embodiments of the invention, the crane 1 comprises a first frame 2 to which one or more motion units 4 are coupled. Each motion unit 4 is configured for the support and motion of the crane 1 on the ground G, for example a dock or quay of a harbour or a shipyard.

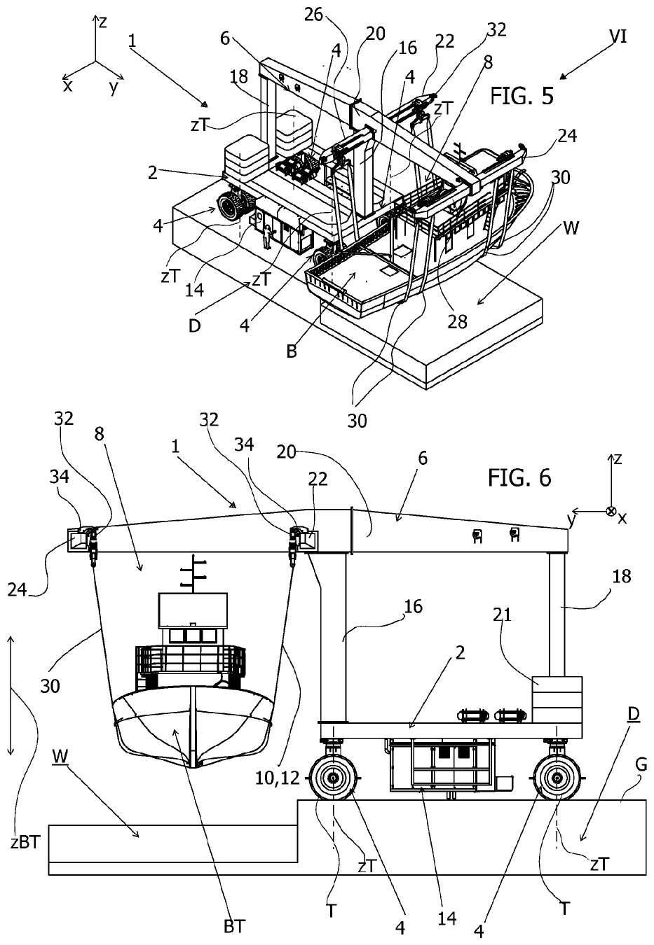

A second frame 6 is installed on the first frame 2, and it comprises a lifting portion 8 including one or more, preferably a plurality of, lifting supports 10, 12 for a boat BT (which is visible in FIGS. 5 and 6). In the embodiment shown in FIGS. 1 to 6, the lifting supports are shown in the number of two, but the number may vary according to the features of the boat BT which is to be lifted and handled.

According to the invention, the lifting portion 8 is arranged projecting with respect to the first frame 2, in such a manner that an (orthogonal) projection on the ground G of the lifting portion 8 is arranged alongside an (orthogonal) projection on the ground of the first frame 2. In other words, the lifting portion 8 projects laterally with respect to frame 2, so that the lifting supports 10, 12 are arranged substantially outside the footprint of the first frame 2.

The motion members 4 may preferably comprise wheel units T (with twin wheels, as in the Figures, or single wheels) installed on hubs pivotally joined to frame 2 around vertical axes zT, so as to impart to crane 1 the ability to steer with respect to the ground G. In the configuration shown in the Figures, the frame 2 is suspended above the wheel units T, in such a manner as to define a height H from ground having a size which is at least equal to the vertical dimension of the wheel units T. The wheel units T may be replaced with crawlers or with rigid wheels, to enable a movement on rails.

However, it shall be borne in mind that embodiments are possible wherein one single motion unit 4 is envisaged, which is implemented, e. g., as an undercarriage having tyred or rigid wheels (e.g., metal wheels for travelling on rails) similar to an earth-moving machine, or as an alternative as a crawler undercarriage (again, similar to those used for earth-moving machines). The undercarriage may be rigidly coupled to the first frame 2, or it may be rotationally coupled thereto by means of a fifth wheel, for a relative rotation around a vertical axis parallel to axis z.

The wheel units T are preferably all provided with autonomous driving, so that the crane 1 is self-driven: in an embodiment, the autonomous driving may comprise a hydraulic motor located in the hub of the wheel units and operatively coupled with a hydraulic circuit supplied by means of a supply unit driven by an internal combustion engine. In other embodiments, the motion unit(s) 4 may be electrically supplied by means of a battery pack installed on board the crane itself, and one or more electric motors connected to the wheels (or generally to the motion members) which can also be used for handling (lifting/releasing) the load weighing on the lifting portion 8.

The supply unit, which for example comprises the internal combustion engine, the hydraulic pump for supplying the hydraulic motors of the wheel units T, an electric generator, an electric panel and other services) may be advantageously housed within a cabin 14 installed suspended below frame 2 and occupying the free height H from the ground.

With reference to FIGS. 1 to 4, in preferred embodiments of the invention the second frame 6 comprises a pair of vertical members 16, 18 installed on the first frame 2 at a base thereof, and a crossmember 20 arranged incident, particularly transverse to, the vertical members 16, 18. The crossmember 20 comprises the lifting portion 8, and is installed at a top of the vertical members 16, 18. Moreover, the vertical members 16 and 18 are preferably installed at end positions on the first frame 2, so that the projection of the crossmember 20 with respect to frame 2, which defines the lifting portion 8, may already originate at an end point, without the necessity of covering a distance which, in a horizontal (orthogonal) projection, would fall into the footprint of frame 2.

Globally, the vertical members 16, 18 define, together with the crossmember 20, a gantry structure which is substantially arranged along a centre plane of the first frame 2, the member 20 further extending in an incident, specifically transverse, direction, with respect to the vertical members 16, 18, so as to define the lifting portion 8. Globally, a second frame 6 of this kind has the shape of a lying and rotated “F”, wherein the parallel flanks of the “F” define the members 16, 18, while the flank incident thereto defines the crossmember 20 (the portion of the “F” which extends beyond the two parallel flanks corresponds to the portion of the crossmember 20 which defines the lifting portion 8).

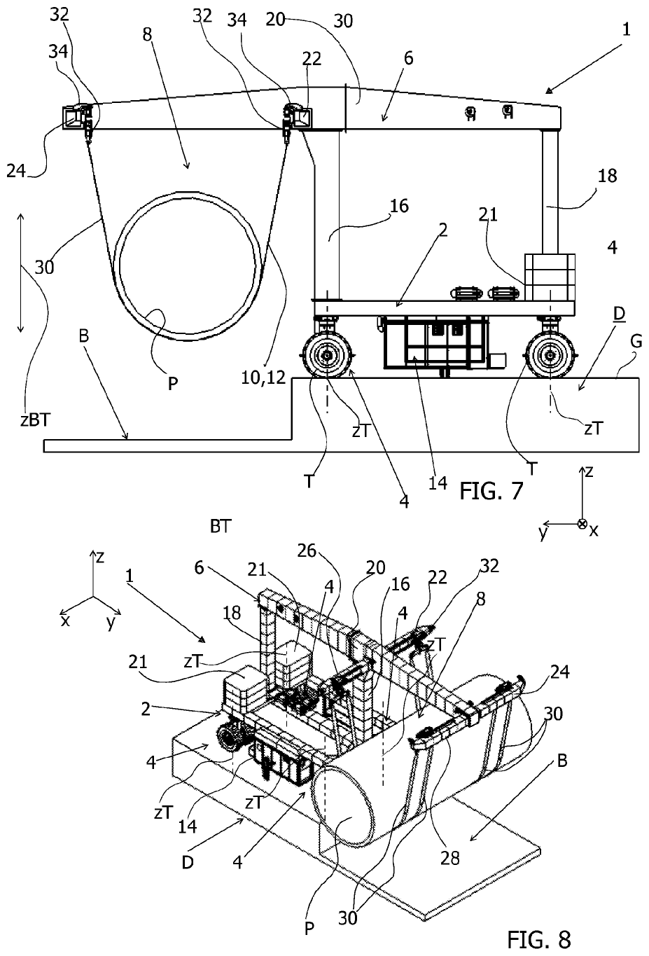

In other words, the lifting portion 8 corresponds to a portion of the second frame 6 which extends cantilever-like with respect thereto and with respect to the first frame 2; this portion is located at a higher position, because it is elevated by the vertical members 16, 18. It shall be borne in mind that it is possible to envisage embodiments of the second frame 6 comprising a single vertical member 16, at the top whereof there is installed, cantilever-like so as do define the lifting portion 8, the crossmember 20 (therefore, the structure has a global shape of a reversed “L” or of a “T”), being again arranged incident or transverse to member 16. Generally speaking, irrespective of the geometry of frame 6, the projecting arrangement of the lifting portion 8 may require one or more counterweights, in order to counteract an overturning moment induced by the lifting portion 8 itself, especially in the presence of a load such as a boat BT or, with reference to FIGS. 7, 8, a pipeline section P. In the presently shown preferred embodiment, a set of counterweights 21 is arranged on the first frame 2 at a first end opposed to a second end, from which the lifting portion 8 protrudes, i.e., which originates the outward projection of the lifting portion 8 (which coincides with the end whereat the vertical member 16 is positioned). It shall be borne in mind, however, that according to needs the counterweights 21 might be housed either on the frame 6 or at a position on frame 2 other than shown in the Figures. Generally speaking, at least one of frame 2 or frame 6 may house one or more counterweights 21.

Always referring to FIGS. 1 to 4, said lifting portion comprises a first pair of beams 22, 24 and a second pair of beams 26, 28, installed on opposed sides of the crossmember 20. The beams 22, 24 and 26, 28 are all arranged cantilever-like with respect to the crossmember 20, and specifically they extend cantilever-like from the section of member 20 which defines the lifting portion 8; they extend transversely to member 20 and are part of the lifting portion 8.

Alternatively, the pairwise configuration of beams 22, 24, 26, 28 may be implemented by means of a single pair of beams, arranged below or above the crossmember 20. In this case, one of the beams corresponds to the set of beams 24, 28, while the other beam corresponds to the set of beams 22, 26. In other words, in such embodiments the first beams 22, 26 of each pair are portions of a single first beam fixed on the extrados or intrados of the crossmember 20 at the lifting portion 8, and the second beams 24, 28 of each pair are portions of a single second beam fixed on the extrados or intrados of the crossmember 20.

Generally speaking, any solution which may originate beam portions projecting pairwise from opposed sides of the crossmember 20 (in the section which defines the lifting portion 8) and extending transversely thereto may be considered appropriate for usage in the embodiments of the invention, because the pairs of protruding beams or beam portions define suspension points for the lifting supports 10, 12, which enable defining a “cradle” whereon the load is received.

Each pair of beams 22, 24 and 26, 28 (or a single pair, as described in the foregoing) carries opposite ends of a respective lifting support 10, 12. Each lifting support 10, 12 comprises one or more hull-bearing or load-bearing bands 30 (typical configurations: one band, double bands, triple bands), at the ends whereof there are attached respective 32 blocks which engage corresponding ropes of one or more winches installed on the crane 1 (on the first frame 2 and/or on the second frame 6). Each winch is configured to control a rise or a descent of block 32 connected thereto, so as to raise or to lower the boat BT the hull whereof lies in a cradle formed by the hull-bearing/load-bearing bands 30. The hull-bearing/load-bearing bands 30 may similarly be utilized for picking up and handling bulky objects other than boat BT, for example (FIGS. 7 and 8) the pipeline section P or any other object in the industry or in the construction sector.

The blocks 32 may advantageously be connected to weight spreaders, according to a pairwise pattern. A first option consists in connecting a first spreader to the blocks 32 of beams 22 and 26, and a second spreader to the blocks 32 of beams 24 and 28. The spreaders are therefore parallel to each other and to the beams 22, 24, 26, 28 (as well as transverse to the member 20). Such a configuration may be useful to increase the number of lifting supports, in order to more evenly distribute the load on the object which is being handled. Actually, the two spreaders may be connected to opposed ends of a plurality of hull-bearing g bands 30 (or, generally speaking, load-bearing bands), specifically in a number higher than would be possible only with the balance wheels coupled to the blocks 32, so as to originate a lifting cradle having more densely arranged bands, which therefore distribute the load more evenly on the object. In the present solution, the cradle keeps the orientation transverse to member 20 (therefore, the cradle is oriented along axis x) which already characterizes the pair of lifting supports 10, 12.

In a second configuration, a first spreader is connected to the blocks 32 of beams 22, 24, and a second spreader is connected to the blocks 32 of beams 26, 28. The spreaders are parallel to each other, but transverse to the beams 22, 24, 26, 28 (and therefore parallel to member 20). If the function of the spreaders is the same as described in the foregoing, i.e. increasing the number of lifting supports in order to more evenly distribute the load on the object which is being handled, in this configuration the cradle of the hull-bearing/load-bearing bands 30 is oriented transversely to the beams 22, 24, 26, 28 (i.e., along axis x) and parallel to member 20; therefore, the cradle is rotated by 90 degrees with respect to the configuration shown in FIGS. 1 to 8.

Preferably, the beams 22, 24 of the first pair are aligned with the beams 26, 28 of the second pair, so that the centre-to-centre distance between the blocks 32 associated to each pair of beams is substantially the same. This condition is automatically met if two beams are provided above or below the crossmember 20. However, it shall be borne in mind that such a condition is not strictly mandatory. Embodiments may be envisaged wherein the beams 22, 24 are offset with respect to the beams 26, 28, e.g., a pair of beams (extending parallel to each other) may have a centre-to-centre distance longer than the other pair of beams (which in turn extend parallel to each other), for example in order to accommodate for special load geometries; for example, for a boat having a delta-shaped hull and a marked longitudinal extension, it may be convenient to have a reduced centre-to-centre distance for the suspension of the support (10 or 12) which is destined to receive a bow section, and a longer centre-to-centre distance for the suspension of the lifting support (12 or 10) destined to receive a stern section. In some embodiments, it is possible to envisage a variation of the relative position between the beams 22, 24, 26, 28 and the member 20, e.g., by installing the beams on guides and by moving them by means of electric or hydraulic motors and a related mechanism for transferring motion.

Moreover, blocks 32 may advantageously be associated with respective sliders 34, which also provide a passage for the winch ropes engaging the respective block. Such sliders may move along guides provided on the beams themselves (with a movement in a direction x34, parallel to axis x). In this way, the ends of the lifting units 10, 12 are movable along the pairs of beams 22, 24 and 26, 28 in such a way as to vary the centre-to-centre distance between the lifting supports 10, 12. The sliders 34 may anyway be replaced by fixed members, e.g. in the case of a small-sized crane 1, which is adapted to handle a range of loads limited as regards weight and dimensions.

Moreover, it will be appreciated that the configuration of crane 1 is such that the lifting supports 10, 12 are provided solely on the lifting portion 8, specifically on the beams 22, 24 and 26, 28, so that they are completely outside the footprint (the projection on the ground) of frame 2.

The operation of the crane 1 is as follows. Generally speaking, the crane 1 performs the same operations as a crane of the known type, the boat being transported while being suspended between the gantry-shaped frames of the crane. The crane 1 is specifically configured to carry a boat BT on the lifting supports 10, 12, in order to move it from and towards a water area (in the sea or in a closed basin) which in the Figures is represented by way of example by a dock D directly facing the water W. The difference in operation, and the consequent technical advantage achieved by the present invention, resides in the fact that the crane 1 according to the invention does not need two bearing points on the ground G, although it comprises-exactly as the known cranes-a double track, i.e. an arrangement of the motion members 4 along mutually parallel directions (in the case of crane 1, it is possible to identify two tracks oriented along directions parallel to axis X or to axis Y). The crane 1 may operate by positioning the first frame 2 thereof at one single area on ground G, while simultaneously positioning the lifting portion 8 already above the water area W where the boat BT is to be picked up or released. Such condition is achievable thanks to the fact that, as described in the foregoing, the lifting portion 8 is arranged protruding with respect to the first frame 2, so that a projection on the ground G of the lifting portion 8 is arranged alongside a projection on the ground G of the first frame 2.

In other words, as the whole lifting portion 8 is arranged outside the projection on the ground (substantially, outside the footprint) of the frame 2, the relative position between the ground and the water area W is unimportant the for execution of the positioning operations. In other words, the only condition to be met is that the surface of the water area W whereat the release or the pickup of boat BT takes place shall be positioned alongside the ground G (in the same way as the projections of the frame 2 and of the lifting portions 8 are arranged alongside each other). However, as it is evident, the side-by-side arrangement corresponds with the continuity between the water and the bank nearby (a dock, a bank, a quay), and therefore the crane 1 is inherently compatible with any site of release or pickup of the boat BT.

In this regard, the provision of the lifting supports 10, 12 solely on the portion of the crossmember 20 which defines the lifting portion 8 guarantees that the position of the boat BT is always totally outside the projection on the ground (or footprint) of frame 2.

Referring to FIGS. 5 and 6, the release and/or the pickup of the boat BT takes place in a manner known in itself, i.e., by surrounding the hull of the boat BT with the bands 30 and controlling the winch(es) the ropes whereof are engaged by the blocks 32, so as to raise or lower the height of the blocks 32, while pulling therewith the bands 30 and the hull of the boat in a raising direction (upwards), or in such a way as to favour the downward pulling induced by the weight of the boat BT while the boat is being lowered towards the water W (motion zBT). The boat BT moves vertically both while rising and while descending, passing along the frame 2 with no superposition or interference, and without having a projection on the ground which may be superposed to the projection of frame 2.

On the contrary, in the cranes of the known type, wherein the boat BT is arranged suspended between two gantry-shaped frames, the release/pickup area of the boat must always be surrounded (at least on two sides) by the ground: such a condition is evidently met only in a limited number of cases, i.e. in basins or docks where the water is flanked by two banks.

The person skilled in the field will therefore appreciate that the crane 1 according to the invention is much more versatile than any known type of crane, because the operation thereof is not bound to the specific morphology of the release/pickup site of the boat BT.

Moreover, with reference to FIGS. 7 and 8, the crane 1 is inherently flexible also as regards its possible applications. For example, it may be used in the field of industry and/or construction for handling bulky objects, such as a pipeline section P which is to be arranged underground at the bottom of an excavation B (in the present case, reference D denotes a bank of the excavation). Similarly to the release of boats BT, any object may be released in a perfectly analogous way: therefore, in the case of releasing the pipeline section P into the bed of excavation B, it is possible to simply position the crane 1 at the edge of the excavation and to lower the pipeline P. In this regard, it will be appreciated that the crane 1 does not require additional works for keeping the position and/or the attitude during the release/pickup operations of the load, and therefore it can operate with a much higher efficiency with respect to a mobile crane which, on the contrary, requires to be stabilized on the ground. In this way, the crane 1 may move about the different areas of the site (or anyway the different areas of action) in very short times. Especially for the usage in industry or construction, the possibility of varying the orientation of the cradle of lifting members by means of spreaders enables a further increase of the flexibility of use of the crane 1.

Of course, the implementation details and the embodiments may widely vary with respect to what has been described and illustrated, without departing from the scope of the present invention as defined in the annexed claims.

1. A crane, comprising:
a first frame to which one or more motion units are coupled, each motion unit of the one or more motion units being configured for the-support and motion of the crane on the ground,
a second frame installed on said first frame, said second frame comprising a lifting portion including one or more lifting supports,
wherein said lifting portion is arranged projecting with respect to said first frame in such a manner that a projection on the ground of said lifting portion is arranged alongside a projection on the ground of said first frame.

2. The crane according to claim 1, wherein said one or more lifting supports are provided solely on said lifting portion.

3. The crane according to claim 1, wherein said second frame comprises one or more vertical members installed on said first frame at a base thereof, and a crossmember arranged transverse to said one or more vertical members, the crossmember comprising said lifting portion, and being installed at a top of said one or more vertical members.

4. The crane according to claim 3, wherein said lifting portion comprises a first pair of beams and a second pair of beams installed on opposite sides of said crossmember, wherein opposite ends of a lifting support of the one or more lifting supports is connected to each pair of the first and second pairs of beams.

5. The crane according to claim 4, wherein first and second beams of the first pair of beams and first and second beams of the second pair of beams are arranged transversely to said crossmember, extending cantilever-like from a section of said crossmember that defines said lifting portion.

6. The crane according to claim 5, wherein the first beams of the first and second pairs of beams are portions of a single first beam fixed on extrados or intrados of said crossmember at the lifting portion, and wherein the second beams of the first and second pairs of beams are portions of a single second beam fixed on the extrados or intrados of said crossmember at the lifting portion.

7. The crane according to claim 4, wherein the ends of the one or more lifting supports are movable along the first and second pairs of beams.

8. The crane according to claim 1, wherein at least one of said first frame and second frame comprises one or more counterweights configured to counteract an overturning moment of said lifting portion.

9. The crane according to claim 7, wherein said one or more counterweights are arranged on said first frame at a first end of said first frame (2) opposite to a second end of said first frame from which said lifting portion protrudes.

10. The crane according to claim 4, wherein the first and second beams of the first pair of beams are arranged, alternatively:
aligned with the first and second beams of the second pair of beams; and
offset from the first and second beams of the second pair of beams.
